(19) United States
(12) Patent Application Publication
(10) Pub. No.: US 2009/0132537 A1
(43) Pub. Date: May 21, 2009

(54) System and Method for Managing Storage and Access of Data Files

(76) Inventor: Daron Denton, Scottsdale, AZ (US)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 12/249,184

(22) Filed: Oct. 10, 2008

Related U.S. Application Data
(60) Provisional application No. 60/988,569, filed on Nov. 16, 2007.

(51) Int. Cl. G06F 17/30

(52) U.S. Cl. 707/9; 707/E17.01; 707/E17.005

(57) ABSTRACT

Disclosed is a system and method for managing storage and access of computer data files by a primary application program. In an exemplary embodiment, the system and method are implemented as an access management program running on a computer that allows access to data files according to permissions granted by the program. The access management program applies the permissions to the existing data file structure on the computer.

### CROSS-REFERENCE TO RELATED APPLICATIONS

This application claims priority to U.S. Provisional Application Ser. No. 60/988,569, filed on Nov. 16, 2007 which is hereby incorporated herein in its entirety.

### STATEMENT REGARDING FEDERALLY SPONSORED RESEARCH OR DEVELOPMENT

Not applicable.

### BACKGROUND OF THE INVENTION

1. Field of the Invention

The present invention is directed generally to a system and method for saving and retrieving computer files. More specifically, the invention is directed to a system and method for managing the storage of, and access to, computer files such that an application program can only save or retrieve files to or from locations allowed by an access management program.

2. Description of Related Art

Computer software applications, or as will be referred to herein as simply “applications,” typically allow a user to create a work product, and then save that work product as a data file to a storage medium such as a hard drive, network server, etc. For example, Microsoft Word® allows a user to create letters and other documents, wherein the user typically saves the created document as a data file to the local hard drive on their computer or workstation, or to a network hard drive (note that while the term “hard drive” will be used herein to refer to a storage device of a computer or server, it should be understood that any other storage medium, such as recordable CDs or DVDs, flash drives, memory sticks, or other data storage mediums known in the art are included when referring to a “hard drive”). The saved data file can then be retrieved by that application, or by another application capable of interpreting or using the data within that file.

Computer files of various types are typically associated with different software application programs. The computer files are typically comprised of data in a specific format, according to the requirements of the application saving or retrieving the file. For example, the well-known Microsoft Word® word-processing application saves and retrieves files in Word® format, with the data in the file being in a specific format required by the Word® application, wherein the data within the file has a particular meaning (such as formatting information, font information, etc.) to the Word® application. In the case of a Word® data file, the file contains all of the information that Word® requires to generate an entire document, including any text within the document and any formatting of the document. Similarly, other application programs have their own associated data file requirements.

In addition to their native data files, many application programs can read and write data files in a common format. For example, Word® can also save and retrieve files in “rich text format” (“RTF”), a standardized format that can be read by numerous word processing programs. Thus, while each application program typically has its own “native” file format, many applications allow saving and retrieving files to and from a common format (such as RTF) to allow a file generated and saved by a first application to be retrieved and used by a second application.

Most applications further include user-accessible controls for saving or retrieving a data file. For example, Microsoft Word® includes a “File” tab on its displayed menu bar, with options to “Save” the current document as a data file or “Open” an existing data file so that the pre-existing document can be viewed or edited. Other applications have similar, if not identical, controls that allow a user to save or open data files. In particular, many applications written to run within the Microsoft Windows® operating system use a common tool bar layout so that users of multiple programs can easily perform common functions using similar or identical controls. For example, upon selecting the “Save” or “Open” control in the tool bar of a program, the user is typically allowed to browse through the file structure of all storage devices connected to their computer or workstation (whether local or networked devices) to select a location in which to save or retrieve a data file. For example, selecting “Save” from the Word® menu bar causes a dialog box to be presented to the user, wherein the dialog box shows, for example, the local hard drive letter(e.g., “C:”) or a network drive letter (e.g., “R:”), and allows the user to navigate to and select any folder or subfolder on those drives as the location in which to store the data file. Thus, an application typically allows users to save a file to any location they desire.

While allowing a user to select where to store data files may be convenient for the user, it is not always desirable to allow that discretion in the context of companies having multiple users. Many companies have standard forms and documents (i.e., “templates”) that they desire to be used whenever a user creates a new document. That template may include, for example, a clause referring to a specific legal or technical standard. If that legal or technical standard changes, the template may be updated to reflect that change so that any documents subsequently created from that template will include the revised clause. However, as described above, applications typically allow a user to save or retrieve documents to or from any location they desire. So, while it may be company policy that new documents must be created from the common template, many users, in fact, create their own libraries of data files, circumventing the company's desire to work from common template files. Thus, a user creating a new document, using the application's ability to save or retrieve documents to or from wherever the user desires, may retrieve a previously-saved file that does not include the latest revisions made to the common template. Similarly, a company may require that all data files be saved in a particular location so that other users may have access to those files, or so that those files can be backed-up or archived, etc. A user not following those requirements, and using the application's ability to save files wherever the user desires, may prevent others from using that file (since others don't know where the user stored the file) or even risk losing the file completely (if it does not get backed-up). Similarly, in the context of architectural design applications, users may be directed to access content only from specific locations. However, a user not following those guidelines may have created their own, private library of favorite, or often used, content. Using that private library, the user may access obsolete or undesirable content.

In order to alleviate problems with applications allowing users to save files to, or retrieve files from, locations of their choosing, various methods of controlling document access have been attempted. One method is for companies to implement document control policies, requiring users to store and retrieve documents to or from specific locations, according to those policies. Another method is to monitor or intercept all “save” and “retrieve” requests by a running application to a separate “file management” application that presents a user with a pre-defined directory structure that allows data files to be stored and retrieved within that structure.

These methods, of course, have drawbacks. Simply setting a company policy does not ensure that users will comply with the policy. Thus, while users may be encouraged or coerced into complying with the policy, nothing in the application or computer system ensures compliance with the policy. And, while a separate file management program can ensure that users subsequently save to or retrieve from pre-defined locations, the file management program does not account for already-existing file structures, and it requires all users of the system to have access to the same common document storage file structure.

### BRIEF SUMMARY OF THE INVENTION

The present invention is directed to a system and method for managing storage and access of computer data files by a primary application program. In an exemplary embodiment, the system and method are implemented as an access management program running on a computer processor that is also running the primary application program. The access management program can be implemented either as a third-party application in communication with the primary application (either as a “plug-in” program that communicates with the primary application via that application's “application program interface” (API), or as stand alone program that otherwise communicates with the primary application). Alternatively, the system and method can be integrated or embedded within the primary application.

The system and method can be implemented and run on an individual computer or workstation, or may be implemented on a server system wherein a host server implements the system and method for one or more users of the server in conjunction with one or more primary applications hosted by the server. In a server-side implementation, individual user settings and permissions as well as permissions relating to each of the primary applications are preferably stored in a database or data file on the server so that the system and method can be easily implemented for multiple users and multiple primary applications in various combinations. In a single computer implementation, the permissions are preferably stored in a database or data file on local hard drive or storage device. Permissions for the users may be stored in a separate database or data file, with the permissions for the primary applications stored in a separate database or data file, or the permissions may be stored in a common database or data file. Whether on an individual computer or on a server-side system, the access management program allows or denies access to the data files based on permissions and restrictions as defined in the user's profile and/or the primary applications' profile as set by a system manager.

### BRIEF DESCRIPTION OF THE DRAWINGS

FIG. 1 is a screen shot of a dialog box for viewing permissions of a client profile used with an access management program according to an exemplary embodiment of the present invention.

FIG. 2 is a screen shot of a dialog box for creating and/or editing permissions of a client profile used with an access management program according to an exemplary embodiment of the present invention

### DETAILED DESCRIPTION OF EXEMPLARY EMBODIMENT

The present invention is directed to a system and method for controlling storage of, and access to, computer data files. In an exemplary embodiment, the system and method is implemented as an access management program operable to interface with one or more primary software applications to allow data files associated with the primary applications to be stored and/or retrieved in accordance with permissions set by a system manager. Permissions may be set for each of a plurality of users of the primary applications and may additionally be set for each of a plurality of primary applications. Thus, permissions can be set for various combinations of users and primary applications.

In one aspect of the invention, a computer administrator uses the access management program to grant or deny permissions to particular areas of a computer storage device according to various criteria, such as the primary application being used, the specific user of the primary application, and the particular file structure on the storage device being accessed (e.g., a file for a particular client). The permissions are thus applied to the existing file structure on the storage device, with the permissions being allowed to vary by clients, users, and/or the primary application being used.

In another aspect of the invention, the access management program interfaces to a primary software application to control that primary application's ability to store or retrieve data files only in accordance with pre-defined permissions, as just discussed. The access management program can be implemented as a third party application in communication with the primary application (either as a “plug-in” program that communicates with the primary application via that application's “application program interface” (API), or as stand alone program that otherwise communicates with the primary application). Alternatively, the access management program can be integrated or embedded within the primary application. In any implementation, the access management program detects any “save” or “retrieve” operations or commands (or other commands relating to data file access) by the primary application program, and imposes restrictions on those operations so that file access can only occur in accordance with the permissions set by the access management program. Thus, access to read or write to/from data files can be restricted by the particular user, the particular primary application being used, and the file structure of the data storage, all as implemented by the access management program.

The system and method can be implemented on an individual computer or workstation, or may be implemented on a server system wherein a host server implements the system and method for one or more users of the server in conjunction with one or more primary applications hosted by the server.

In a single computer or workstation implementation, the access management program and associated permissions are typically stored on the computer's local storage device, such as a hard drive. The access management program is implemented either as a third party add-on (such as a plug-in) to one or more primary applications, or can be embedded as a part of the primary applications.

In a server-side implementation, individual user settings and permissions as well as permissions relating to each of the primary applications are stored on the server so that the access management program system and method can be easily implemented for multiple users and multiple primary applications in various combinations. As with the single computer implementation, a server-side implementation of the access management program can be implemented as a third-party add-on or plug-in to various primary applications, or can be embedded within the primary applications.

Whether on an individual computer or on a server-side system, the access management program allows or denies access to data files based on permissions and restrictions as defined in the profiles for the users and applications, as set by a system manager.

In an add-on or “plug-in” implementation, the access management program uses hooks into the application as defined by that application's API (application programming interface). Running in conjunction with the application, the add-on or plug-in access management program detects user requests to save or access data files (such as “Save”, “Open” or comparable commands, depending on the application) made through the application, and directs those requests through the access management program, imposing the permissions and restrictions for a particular client and/or user (as defined by a system manager) to prevent the application from writing data files to, or reading data files from, any areas not permitted by the access management program. Thus, for example, a system manager of an architectural design program, such as Revit®, can assign profiles for various clients and various users, so that particular users can only access data files from areas on the hard drive (i.e., the hard drive's folder structure) if the profile allows them to do so. Similarly, in addition to Revit® the system manager can assign profiles for other primary applications to define permissions for that application and for the users of that application. Thus, the access management program can control the access for various combinations of users, various combinations of primary applications, and various existing directory structures.

In an exemplary embodiment of the present invention, an access management program provides: (i) a “Create/Edit Profiles” dialog box that allows a system manager to create and edit profiles for users of the system and/or to create profiles for primary applications running on the system, the profiles defining the permissions and restrictions in accessing the existing file and folder structure on the storage device; and (ii) a “Profile Settings” dialog box that allows viewing of the permissions and restrictions for a user and/or primary application with respect to the folder structure on the storage device. The access management program is implemented either as an add-on or plug-in that works conjunction with the primary applications as described previously, or as an integral, embedded part of the primary applications. In operation, the access management program implements and applies the restrictions to the application, thus limiting access to the storage device according to the permissions and restrictions set for that user and/or application as applied to the existing file structure.

An exemplary embodiment of an access management program in accordance with the present invention will be discussed hereinbelow in the context of use with the architectural design program Revit®. In that context, access to data files is managed on a client level. That is, all data files associated with a particular client are managed by the access management program, with individual users having permissions and restrictions assigned with respect to that client. It will be understood by those skilled in the art that, depending on the applications with which the access management program is used, the permissions and restrictions may be assigned on a user level (rather than, or in addition to a client level), with each user of the application being assigned permissions and restrictions in a manner similar to that described herein. Similarly, it will be understood that permissions and restrictions may be assigned according to the primary application, with different applications having different permissions and restrictions. Thus, the level of permissions can vary according the primary application being run, the user of that application, and the client for which the user is using the primary application. That and other minor variations in implementing the system and method described herein are within the scope of the present invention.

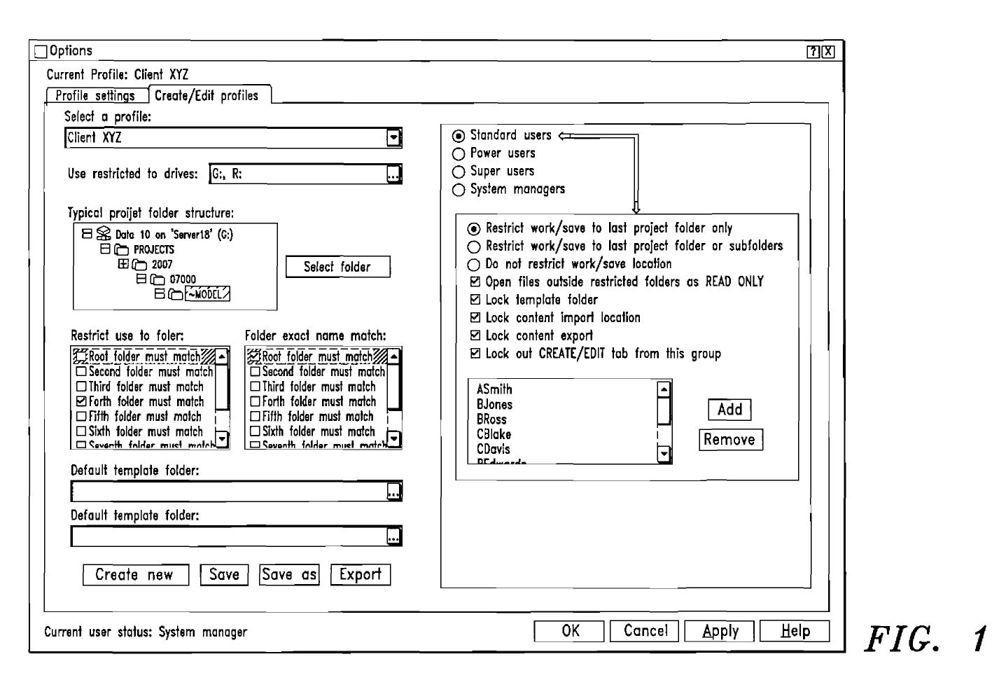

A screen-shot of the “Create/Edit Profiles” dialog box of an exemplary access management program in accordance with the present invention is depicted in FIG. 1. As shown in FIG. 1, the “Create/Edit Profiles” dialog box includes a “Select a profile” input box having a pull-down menu for selecting an existing client profile. In conjunction with the “Create new” button at the bottom of the dialog box, the system manager can either select an existing client profile to edit, or can create a new profile for a new client. When creating a new client profile, the input fields (described below) of the dialog box will initially be blank, and the checkboxes will be unselected. When editing an existing client profile, the input fields and checkboxes will reflect the last-saved state and attributes of those fields and checkboxes. As seen in FIG. 1, for existing hypothetical client “Client XYZ,” the input fields and checkboxes indicate the permissions and restrictions set for that client. As will be described, the permissions and restrictions will be assigned according to the existing hard drives (or other storage devices) and existing folder structure on the system.

Looking first to the “Use restricted to drives:” input box, the system manager can allow access to any of the available hard drives on the system. All of the available drives can be viewed by pressing the ellipsis (“. . . ”) box at the end of the input field, and individual drives may be added to the input box as they are selected. In the example shown, drives “G:” and “R:” have been selected. Thus, a user of an application working on a project for Client XYZ will only be allowed to access drives “G:” and “R:”.

Permissions and restrictions to access particular folders on those drives is assigned using the “Typical project folder structure:” box and associated “Select folder” button, in conjunction with the “Restrict use to folder:” and “Folder exact name match” checkboxes. Using the “Typical project folder structure:” box, the system manager can peruse through the existing folder structures on the various hard drives or storage devices of the system, and grant permissions to access selected folders using the checkboxes. Looking to the example in FIG. 1, for a system having data files stored on Drive G:, with a “PROJECTS” folder having a “2007” subfolder, the “2007” subfolder having a “07000” subfolder, and the “07000” subfolder having a “˜Model” subfolder, the system manager has selected that: (i) use be restricted to the fourth folder matching, and (ii) the name of the root folder must match. Note that the folder restrictions applied will allow access to any fourth-level folder named “˜MODEL” having a root folder named “PROJECTS”, regardless of the intervening sub-folders. Thus, while the example shows a folder structure of [PROJECTS]-[2007]-[07000]-[˜MODEL], the permissions/restrictions will also permit access to folder structures of, for example, [PROJECTS]-[2008]-[07000]-[˜MODEL], or even [PROJECTS]-[ABC]-[DEF-[˜MODEL]. The permissions require only that the root folder and fourth level folder match as selected by the checkboxes. Of course, more aggressive (i.e., restrictive) permissions/restrictions could be set by using different combinations of the checkboxes to restrict access by folder levels and folder exact name matches. Note also that the selected restrictions are applied to the existing file structure on the hard drive. The access management program does not require copying existing files into a restricted area reserved by the access management program.

Aggregating the restrictions set as described thus far in the example of FIG. 1, a user working on a project for Client XYZ will be restricted to accessing only drives “G:” and “R:” of the system (regardless of any other drives on the system), and will further be restricted to accessing fourth-level folders having the name “˜MODEL” in which the root folder is named “PROJECTS.” Thus, folders on those drives in which the fourth-level folder is named “˜MODEL” and in which the root folder is named “PROJECTS” will be accessible to a user using the Client XYZ profile, while access to any other folders will be denied. Of course, other folder permissions and restrictions can be set by the system manager by checking or unchecking the appropriate checkboxes. As seen in FIG. 1, “Restrict use to folder:” checkboxes and “Folder exact name match:” checkboxes allow the system manager to apply restrictions to any desired sub-folder level.

The “Default template folder” and “Default content folder” input boxes allow the system manager to browse the hard drive(s) and select the default folder from which template and content data files will be accessed through the Revit(V program. For example, a user working on a project for Client XYZ of the Revit® program, requesting to open a template, will be presented only with the template data files in the default folder set by the system manager in the “Default template folder:” input box. Likewise, a user wanting to retrieve a content data file will be presented only with the content data files in the default folder set by the system manager in the “Default content folder:” input box. Thus, a user is initially directed to the default folders when accessing and/or saving templates and content.

Looking to the right-hand side of the dialog box of FIG. 1, within the profile of Client XYZ, further restrictions for individual users, based on the classification of that user, can be imposed by the system manager. At the top right, four radio buttons allow the system manager to select a classification of user—“Standard users”, “Power users”, “Super Users”, or “System managers.” These classes of users allow a system manager to assign common permissions and restrictions to users by placing them in the appropriate class. For example, a “standard user” may be granted minimal permissions, whereas a “super user” may have virtually unrestricted access. Using the checkboxes and text/scroll box (as described in more detail below), the system manager can set the various permissions for a class of user, and assign individual users to the different classes. Using the scroll box in conjunction with the “Add” and “Remove” buttons, the system manager can scroll through a pre-defined list of usernames and choose to add or remove them from a particular class. In addition, for each class of users, the system manager can select one of the three radio buttons to: (i) restrict access to only the last project folder in the folder structure using the “restrict work/save to last project folder” button; (ii) restrict access to the last project folder and any sub-folders using the “restrict work/save to last project folder or subfolders” button; or (iii) not restrict access at all by selecting the “do not restrict work/save location” button.

Finally, the system manager can use the check boxes to select whether a class of users can be allowed to open files outside of the permitted folders as read only (by selecting the “open files outside restricted folders as READ ONLY” checkbox), restrict all write access to the template folder (by selecting the “Lock template folder” checkbox), restrict access to the content folder (using the “lock content import location” and “lock content export” checkboxes), and restrict access to the CREATE/EDIT set-up tab (by selecting the “lock out CREATE/EDIT tab from this group” checkbox. The “lock out CREATE/EDIT tab from this group” checkbox allows the system manager to restrict the ability of other users (even other system managers) from accessing the dialog box of FIG. 1 and changing the permissions of any users.

Thus, for each client profile, the system manager can use the radio buttons to select the various classes of users (standard, power, super, and system managers) and set the directory structure access for each class of user, set any other restrictions on that class of user's access, and assign users to that class. With all of the permissions and restrictions set, the system manager presses the “Save” button to save the settings for the client profile. If any additional changes are ever required, the system manager can load the profile, make any changes to the permissions and restrictions, and again save the profile.

Using the other buttons at the lower left of the dialog box, the system manager can create a new profile, save the profile under a different name (using the “Save as” button), or export the profile to an external file for use by another program (using the “Export” button). Exported profiles can also by used by other computer systems (at other locations, or third party locations) to allow collaboration on the same project, using the same specific folder structures.

As will be apparent the dialog box in FIG. 1 depicts an access management program in accordance with an exemplary embodiment of the present invention in use with a typical folder structure used by the Revit® architectural application program. Of course, the access management program may also be used in conjunction with other application programs that may use a different folder structure. The permissions for the folder structures of those applications will be set in a manner similar to that just described, although the specific folder structure will vary from the Revit® structure depicted in FIG. 1. Thus, the access management program can be used with various primary applications running simultaneously or separately on the computer system.

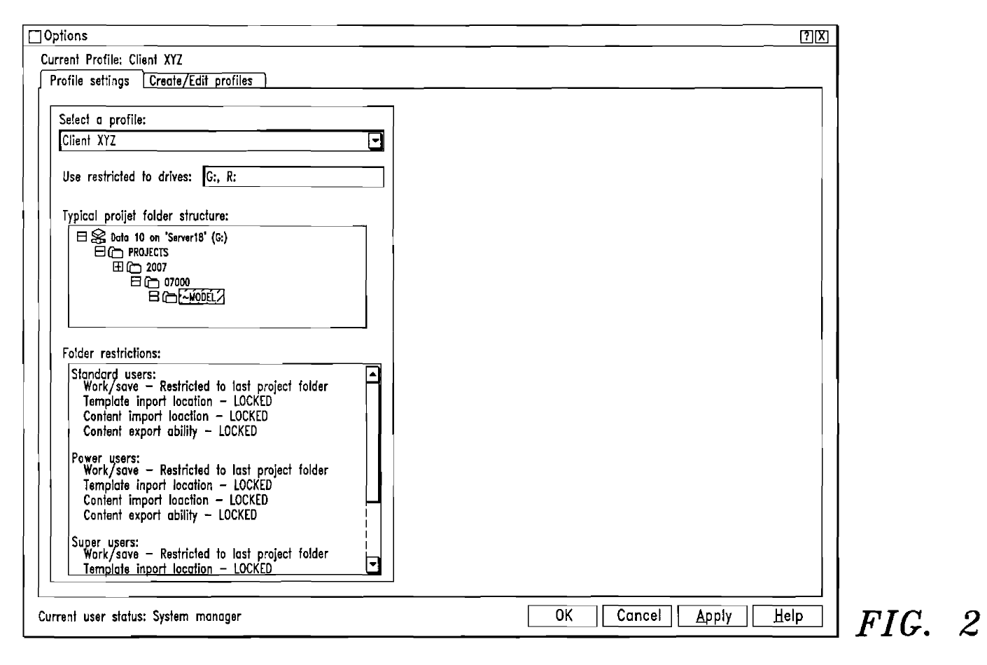

Turning to FIG. 2, the “Profile Settings” tab of the dialog box summarizes and displays the permissions and restrictions set by the system manager, as explained above. Using the “Select a profile” input box, the system manager selects a profile to view, in this example, Client XYZ. The “Use restricted to drives:” and “Typical project folder structure:” boxes display the folder structure access assigned to Client XYZ (as described above), with the “Folder restrictions” box displaying the additional restrictions for each class of user (as described above). Thus, the system manager can quickly view the directory structure and permissions for all classes of users at once. Other users can also view the settings and switch to different client profiles as need to work on other projects that have different folder settings. And, as described above, various primary applications may have their own folder structures, in which case the access management program running in conjunction with that primary application will display the corresponding file structure and permissions.

In use, the access management program operates either as an add-on or “plug-in” program (i.e., a third-party program) that runs in conjunction with a desired primary application, interfacing to the primary application as described above, or operates as an embedded or integral part of the primary application. In add-on or plug-in use, the access management program uses features of the application defined by that application's API to control various aspects of the application. In embedded or integral use, the access management program is a part of the primary application such that access requests in the primary application are internally directed to the access management program embedded therein.

In the example described herein, the access management program is configured to run in conjunction with Revit®, an architectural design program. It will be apparent to those skilled in the art that the access management program could be adapted to interface with other applications, and/or with additional applications, and that the dialog box of the access management program could be adapted to conform to the specific requirements of that application (for example, a version of the access management program for use as a plug-in to the email application Outlook® could refer to a “default mail folder”, etc.).

With the access management program running as a plug-in to Revit®, and the permissions and restrictions set for each client profile (and users within that profile) as described above, any user requests for file access (or any other application features available through the application's API, or internally in the case of an embedded access management program) made through the Revit® application will be directed through the access management program. Or, that feature of the application may be disabled, or presented as inaccessible (e.g., “greyed out”) to the user. Thus, for example, a user of Revit® requesting to access a data file will be presented with a directory structure showing all available hard drives and folder structures, but data file access would be restricted to the hard drives and folder structures set by the system manager for that client profile as described above. Attempting to access a file outside of the permitted hard drive would result in Revit® “greying out” the “Open” and “Save” buttons displayed to the user, and/or would not permit the selection of those files by the user. In addition, the particular user of Revit® may have additional restrictions imposed as set in the profile for that class of user, as described above. For example, a user set as a “standard user” with permission to open files outside restricted folders as READ ONLY, would be allowed to browse through all folders on any allowed hard drive, but would be restricted to read-only access to any file outside of the permitted [PROJECTS]-[2007]-[07000]-[˜MODEL] folder. Similarly, a user having the “lock content export” restrictions (as described above) would see the “export content” command of Revit® “greyed out” and inaccessible. The access management program, running in conjunction with Revit®, and using features accessible through Revit's®P API, thus implements the restrictions and permissions defined in the user profile.

In operation as either an embedded application or as a plug-in, the restrictions of the access management program are imposed to users transparently—most users will not even be aware that the access management program is running. The user will simply see the standard screens of the Revit® program, with the access management program controlling some of the features of Revit® to implement the restrictions and permissions of that user as described herein.

Thus, the access management program allows a system manager to control access to files of a particular client by seamlessly imposing permissions and restrictions through the application. In the case of Revit®, the access management program allows a system manger to force content to be stored in specific locations, or to restrict users from writing to the template folder and inadvertently corrupting a template file. Furthermore, the access management program works in conjunction with existing file structures; it does not require setting up a new, restricted storage area or require copying files into the access management program.

Of course, while the access management program of the present invention has been described primarily in conjunction with the Revit® program, it will be apparent that the invention is suitable for use with any application having an application programming interface. In addition, while the exemplary access management program described herein has referenced particular features of Revit® (i.e., content files and template files), other features accessible through the application programming interface may also be implemented, and are within the scope of the present invention.

What is claimed and desired to be secured by Letters Patent is as follows:

1. A method for managing storage of and access to data files on a storage medium, comprising:
defining user permissions and restrictions for at least one user of at least one primary application operable to run on a computer system;
detecting at least one data file access request by said at least one primary application; and
applying said defined user permissions and restrictions to said access request and granting or denying access to the data file in accordance therewith.

2. The method of claim 1, further comprising:
defining application permissions and restrictions for said at least one primary application; and
applying said defined application permissions and restrictions to said access request and granting or denying access to the data file in accordance therewith.

3. The method of claim 1, wherein said defining step comprises selecting storage areas on said storage medium from pre-existing data file structure on said storage medium.

4. The method of claim 1, wherein said applying step comprises comparing said access request to said defined user permissions and restrictions.

5. The method of claim 1, further comprising:
notifying said primary application of said granting or denying of access.

6. A method for managing storage of and access to data files on a storage medium, comprising:
defining permissions and restrictions for at least one user and at least one primary application operable to run on a computer system;
detecting at least one data file access request by said at least one primary application; and
applying said defined permissions and restrictions to said access request and granting or denying access to the data file in accordance therewith.

7. The method of claim 6, further comprising:
notifying said primary application of said granting or denying of access.

8. A computerized method of granting and restricting access to a data file on a storage medium in accordance with pre-defined permissions and restrictions, comprising:
receiving a request for access to said data file from a primary application;
applying said permissions and restrictions to said request for access; and
granting or denying access to said data file in accordance with said permissions and restrictions.

9. The computerized method of claim 8, wherein said predefined permissions and restrictions comprise user permissions and restrictions, primary application permissions, or combinations thereof.

10. The computerized method of claim 8, wherein said permissions and restrictions are applied to existing folder structure on said storage medium.

11. The computerized method of claim 8 further comprising:
notifying said primary application of said granting or denying of access.

12. A computer-readable medium having computer-executable instructions for performing a method of granting and restricting access to a data file on a storage medium in accordance with pre-defined permissions and restrictions, said method comprising:
receiving a request for access to said data file from a primary application;
applying said permissions and restrictions to said request for access; and
granting or denying access to said data file in accordance with said permissions and restrictions.

13. The computer-readable medium of claim 12, wherein said predefined permissions and restrictions comprise user permissions and restrictions, primary application permissions, or combinations thereof.

14. The computer-readable medium of claim 12, wherein said permissions and restrictions are applied to existing folder structure on said storage medium.

15. The computer-readable medium of claim 12, wherein said method further comprises:
notifying said primary application of said granting or denying of access.

16. A system for managing access to data files on a storage device, comprising:
a storage device;
at least one processor operable to:
maintain in said storage device a database identifying at least one primary application and corresponding access rules;
detect a data file access request originating from said at least one primary application; and
grant or deny said access request in accordance with said primary application access rules.

17. The system of claim 16, wherein said processor is further operable to:
maintain in said storage device a database identifying at least one username and corresponding access rules; and
grant or deny said access request in accordance with said usemame access rules.

18. The system of claim 16, wherein said access rules are applied to pre-existing data structure on said storage device.

19. The system of claim 16, wherein said processor is further operable to:
notify said primary application of said granting or denying of access.
